(19) United States
(12) Patent Application Publication
(10) Pub. No.: US 2014/0236469 A1
(43) Pub. Date: Aug. 21, 2014

(54) ONBOARD MAP DISPLAY OF POSITIONS OF OTHER AIRCRAFT FLYING IN THE VICINITY OF AN INDIVIDUAL AIRCRAFT

(71) Applicants: DANIEL EDWARD CALLAN, SAN DIEGO, CA (US); EDWARD WILLIAM CALLAN, SAN DIEGO, CA (US)

(72) Inventors: DANIEL EDWARD CALLAN, SAN DIEGO, CA (US); EDWARD WILLIAM CALLAN, SAN DIEGO, CA (US)

(21) Appl. No.: 13/432,794

(22) Filed: Mar. 28, 2012

Related U.S. Application Data
(60) Provisional application No. 61/492,938, filed on Jun. 3, 2011.
(60) Provisional application No. 61/471,593, filed on Apr. 4, 2011.
(60) Provisional application No. 61/471,602, filed on Apr. 4, 2011.

(51) Int. Cl. G08G 5/04; G08G 5/00

(52) U.S. Cl. 701/301; 701/300

(57) ABSTRACT

Onboard an individual aircraft, a map showing aircraft flying in the vicinity of the individual aircraft is displayed on a monitor. Navigation satellite technology, such as GPS, onboard the individual aircraft is used to determine the position of the individual aircraft. Via a communications network, position-indication signals indicating the determined positions of the individual aircraft and other aircraft flying in the vicinity of the individual aircraft are sent between the different aircraft. Onboard the individual aircraft, a computer processes the position-indication signals to provide display signals that enable a monitor onboard the individual aircraft to display a map showing the positions of other aircraft flying in the vicinity of the individual aircraft in relation to the position of the individual aircraft. In one embodiment, a website that communicates with the different aircraft via the Internet facilitates communication of the position-indication signals between the different aircraft.

### CROSS REFERENCE TO RELATED APPLICATION

This is a continuation-in-part of co-pending application No. 61/492,938 filed Jun. 3, 2011, which is a continuation-in-part of co-pending application No. 61/471,602 filed Apr. 4, 2011. This is also a continuation-in-part of co-pending application No. 61/471,593 filed Apr. 4, 2011.

### BACKGROUND OF THE INVENTION

The present invention pertains to displaying a map of aircraft flying in the same vicinity.

It is known to process signals indicating the positions of in-flight aircraft at a control center to provide display signals that enable a monitor at the control center to display a map showing the positions of aircraft flying in a particular sector of airspace. It is also known to process signals that are provided by using radar technology to provide the signals that indicate the positions of in-flight aircraft that are processed to provide the display signals. In addition, it has been proposed to process signals that are provided by using satellite navigation technology to provide the signals that indicate the positions of in-flight aircraft that are processed to provide the display signals.

### SUMMARY OF THE INVENTION

The present invention provides a method of displaying onboard an individual aircraft, a map showing aircraft flying in the vicinity of the individual aircraft, comprising the steps of:

(a) onboard each of a plurality of individual aircraft, determining the position of the individual aircraft and providing a position-indication signal indicating said determined position of the individual aircraft;

(b) via a communications network that enables communications between the individual aircraft and other aircraft flying in the vicinity of the individual aircraft, sending position-indication signals from the individual aircraft to other aircraft that are flying in the vicinity of the individual aircraft; and

(c) onboard the individual aircraft, receiving via the communications network position-indication signals sent by other aircraft flying in the vicinity of the individual aircraft, and with a computer, processing the position-indication signals to provide display signals that enable a monitor onboard the individual aircraft to display a map showing the positions of other aircraft flying in the vicinity of the individual aircraft in relation to the position of the individual aircraft.

In a further aspect, the present invention provides a method of displaying onboard an individual aircraft, a map showing any aircraft flying in the vicinity of the individual aircraft, comprising the steps of:

(a) with a computer, processing signals indicating the positions of in-flight aircraft to provide display signals that enable a monitor to display a map showing the positions of aircraft flying in a particular sector of airspace;

(b) sending at least a portion of said display signals to aircraft in the particular sector of airspace; and

(c) onboard an individual aircraft flying within the particular sector of airspace, receiving the sent display signals, and with a computer, processing the received display signals to cause an onboard monitor to display a map showing the positions of other aircraft flying in the vicinity of the individual aircraft in relation to the position of the individual aircraft.

The present invention additionally provides nontransitory computer readable storage media containing computer executable program instructions for causing one or more computers to perform and/or enable one or more steps of the above-described methods.

Additional features of the present invention are described with reference to the detailed description of the preferred embodiments.

### BRIEF DESCRIPTION OF THE DRAWING

FIG. 1 is a block diagram of one exemplary embodiment of a system according to the present invention.

FIG. 2 illustrates an exemplary onboard monitor display of the positions of aircraft flying in the same vicinity, as provided by the present invention.

FIGS. 3A, 3B and 3C, in combination, provide a diagram of aspects of an exemplary embodiment of the method of the present invention that utilizes the embodiment of the system shown in FIG. 1.

FIG. 4 is a block diagram of another exemplary embodiment of a system according to the present invention.

FIGS. 5A and 5B, in combination, provide a diagram of some of the aspects of an exemplary embodiment of the method of the present invention that utilizes the embodiment of the system shown in FIG. 4.

FIG. 6 is a block diagram of an exemplary embodiment of a system according to the further aspect of the present invention.

FIGS. 7A and 7B in combination provide a diagram of an exemplary embodiment of the method of the further aspect of the present invention.

### DETAILED DESCRIPTION

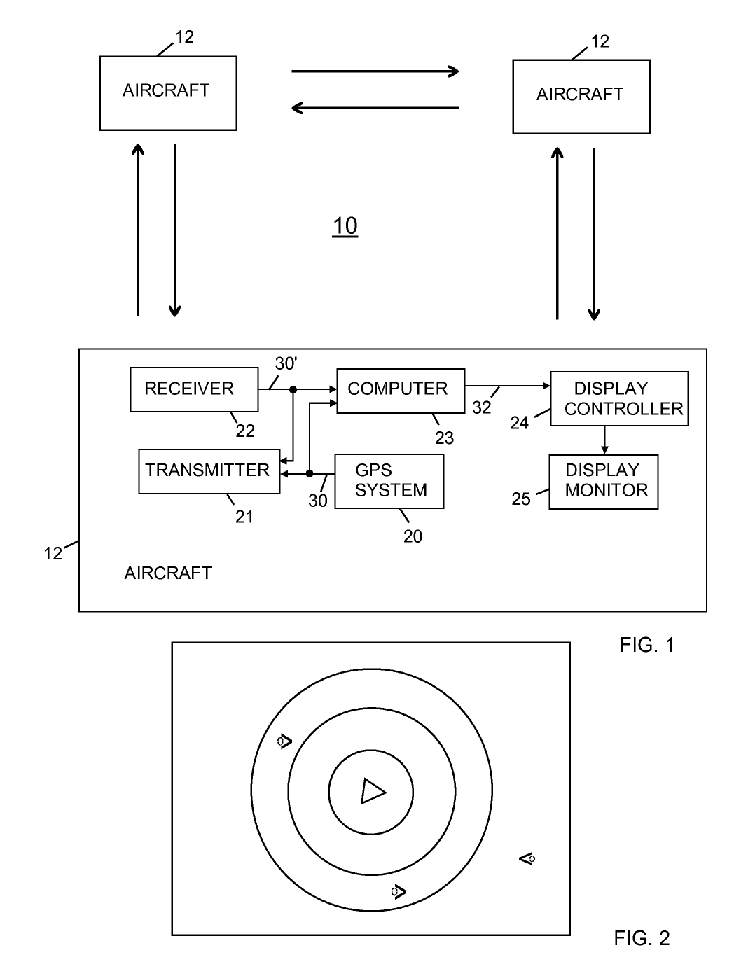

Referring to FIG. 1, one exemplary embodiment of a system according to the present invention utilizes a communication network 10 having nodes onboard each of a plurality of individual aircraft 12. Onboard each of the individual aircraft 12, the system includes a GPS system 20, a transmitter 21, a receiver 22, a computer 23, a display controller 24 and a display monitor 25. The computer 23 and the display controller 24 may be embodied in more than one individual computer.

The communications network 10 enables communications between the individual aircraft 12 and other aircraft 12 flying in the vicinity of the individual aircraft 12. Preferably, the communications network 10 is a transitory mesh network that utilizes Wi-Fi technology, radio technology and/or GSM technology; wherein interference between signals transmitted from more than one aircraft 12 is resolved by using time-division-multiplexing (TDM) technology, spread spectrum technology and/or TASI technology.

Each of the individual aircraft 12 may include a database of alternative transmission time slots and/or spread spectrum transmission patterns for selection by the transmitter when interference between signals transmitted from different individual aircraft is detected during a handshake routine performed upon initiation of a signal transmission that uses a default transmission time slot and/or spread spectrum transmission pattern for transmissions from the individual aircraft 12. Signals communicated via the network 10 are received by the individual aircraft 12 within a frequency band assigned by a regulatory agency for communications within the network 10.

The GPS system 20 determines the position of the individual aircraft 12 and provides an updated position-indication signal 30 including position data indicating the determined position of the individual aircraft 12 and identifying the individual aircraft 12. The position data indicates the latitude, longitude and altitude of the individual aircraft 12.

The transmitter 21 repeatedly sends the updated position-indication signals 30 via the communications network 10 from the individual aircraft 12 to other aircraft 12 that are flying in the vicinity of the individual aircraft 12.

Via the communications network 10, the updated position-indication signals 30 sent by other aircraft 12 flying in the vicinity of the individual aircraft 12 are received continuously by the receiver 22.

In one or more embodiments, the transmitter 21 onboard the individual aircraft 12 combines the position-indication signal 30 indicating the determined position of the individual aircraft 12 with position-indication signals 30′ that are being received from other aircraft flying in the vicinity of the individual aircraft to provide combined position-indication signals 30′ for sending to other aircraft that are flying in the vicinity of the individual aircraft. Accordingly, an individual aircraft 12 can receive position-indicating signals 30′ transmitted from other aircraft that are not within the reception range of the receiver 22 in the individual aircraft 12 but are within the reception range of receivers in the other aircraft from which the individual aircraft 12 receives the combined position-indication signals 30′. In one or more of these embodiments, the combined position-indication signals 30′ are compressed for transmission.

In one or more embodiments, the GPS system 20 updates the position-indication signals 30 for the individual aircraft 12 several times per second; and/or the transmitter 21 also continuously sends the updated combined position-indication signals 30′ received from other aircraft 12.

Onboard each of a plurality of individual aircraft 12, the accessed position-indication signals 30′ are processed continuously by the computer 23. The computer 23 is programmed by computer executable instructions contained in a nontransitory computer readable storage medium. These computer executable program instructions cause the computer 23 to process the continuously received position-indication signals 30′ and the updated position-indication signal 30 provided by the onboard GPS system 20 to provide display signals 32 that enable the display monitor 25 to display a map showing the updated positions of other aircraft 12 flying in the vicinity of the individual aircraft in relation to the position of the individual aircraft 12.

The computer 23 is also programmed to process the position-indication signals 30, 30′ so that the display signals 32 associate the aircraft positions with the aircraft identities. Preferably, the display signals 32 indicate rectangular longitude and latitude coordinates for the positions of the aircraft.

In one or more embodiments, the computer 23 is also programmed to process a sequence of position-indication signals 30, 30′ for each of the different individual aircraft 12 so that the display signals 32 indicate the direction in which each of the different individual aircraft 12 is flying.

In one or more embodiments, the computer 23 is also programmed to process a sequence of position-indication signals 30, 30′ for each of the different individual aircraft 12 so that the display signals 32 indicate the ground speed of each of the individual aircraft 12 and/or the distance in three-dimensional space between the individual aircraft 12 containing the computer 23 and each of the other individual aircraft 12.

The display signals 32 are provided to the display controller 24, which controls the formation of the map by the display monitor 25. An exemplary map display is shown in FIG. 2. The display controller 24 may be operated to adjust the scale of the display map to display the positions of other aircraft 12 that are flying within a selected distance of the individual aircraft 12, such as within five, ten or fifteen miles, for example. On the displayed map, the distance between the circles represents five miles.

The unique identity of the individual aircraft 12 is stored in the display controller 24 that is onboard each individual aircraft 12. The display controller 24 processes the aircraft identities included in the display signals 32 by comparing the stored unique aircraft identity of the individual aircraft 12 with the aircraft identities included in the display signals 32, and upon matching the stored unique aircraft identity with the aircraft identity that is included with the position data in the display signal 32 for the individual aircraft 12, causes the position of the individual aircraft 12 to include a distinguishing feature, such as color or shape, that is not included in the displays of the positions of other aircraft 12, and further causes the display of the position of the individual aircraft 12 to be maintained in approximately the same place, on the displayed map, such as in the center, while the position of the individual aircraft 12 is changing with respect to the ground.

In one or more alternative embodiments, the position-indication signals 30, 30′ do not include the identities of the individual aircraft; wherein the display controller 24 identifies the position-indication signal 30 provided by the GPS system 20 onboard the individual aircraft 12 as indicating the position of the individual aircraft 12 and thereupon causes the position of the individual aircraft 12 to include a distinguishing feature, such as color or shape, that is not included in the displays of the positions of other aircraft 12, and further causes the display of the position of the individual aircraft 12 to be maintained in approximately the same place, on the displayed map, such as in the center, while the position of the individual aircraft 12 is changing with respect to the ground.

In those embodiments in which the display signals indicate the direction in which each of the different individual aircraft 12 is flying, the leading edge of the displayed position of an individual aircraft is pointed in the direction indicated by the respective display signal for the individual aircraft 12.

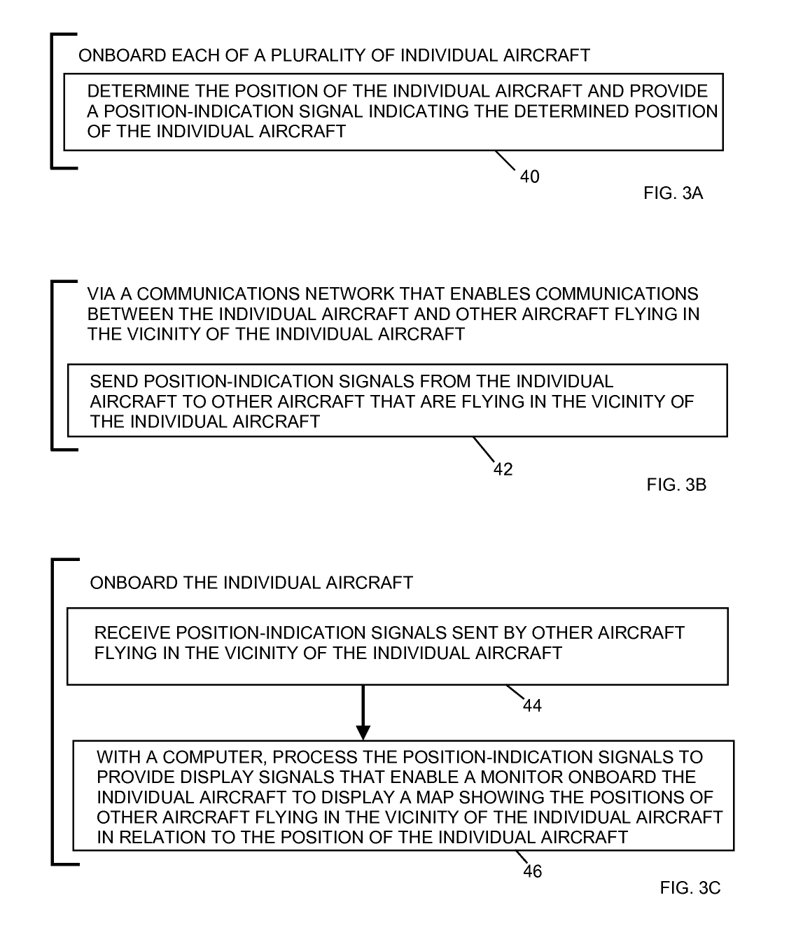

An exemplary embodiment of the method of the present invention is described with reference to FIGS. 3A, 3B and 3C.

Onboard each of a plurality of individual aircraft, the position of the individual aircraft is determined to provide a position-indication signal indicating the determined position of the individual aircraft, as shown at 40.

Via a communications network that enables communications between the individual aircraft and other aircraft flying in the vicinity of the individual aircraft, position-indication signals are sent from the individual aircraft to other aircraft that are flying in the vicinity of the individual aircraft, as shown at 42.

Onboard the individual aircraft, position-indication signals sent by other aircraft flying in the vicinity of the individual aircraft are received via the communications network, as shown at 44; and the position-indication signals are processed with a computer to provide display signals that enable a monitor onboard the individual aircraft to display a map showing the positions of other aircraft flying in the vicinity of the individual aircraft in relation to the position of the individual aircraft, as shown at 46.

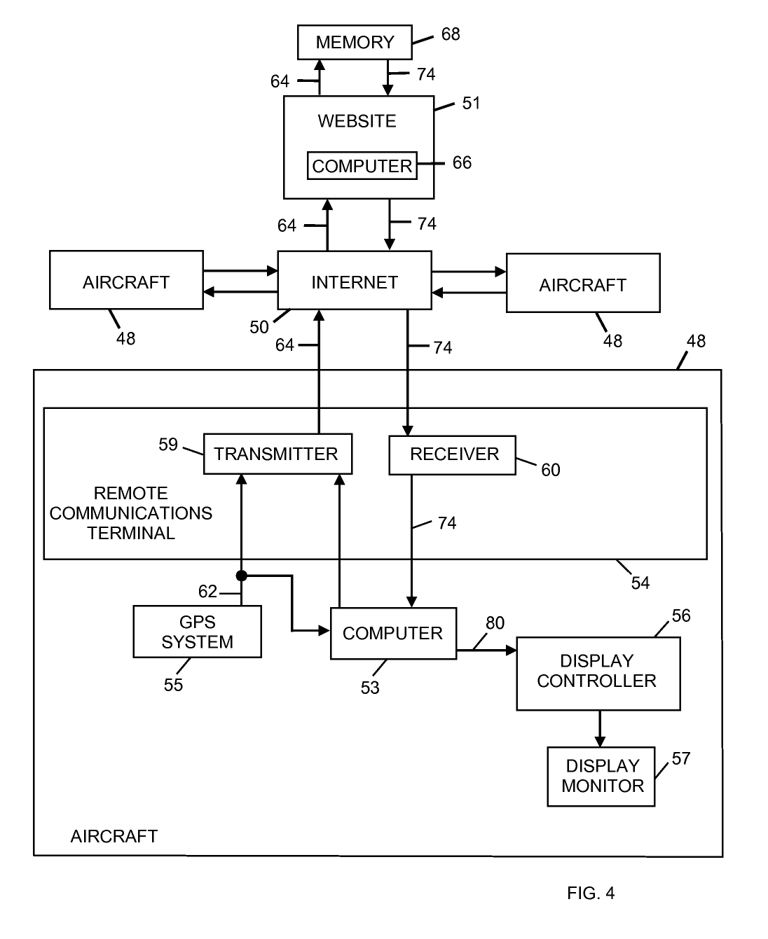

Another exemplary embodiment of a system according to the present invention for displaying onboard an individual aircraft 48, a map showing aircraft 48 flying in the vicinity of the individual aircraft 48 is shown in FIG. 4. This other exemplary embodiment includes a communication network 50, a website 51 and the following apparatus within each of the individual aircraft 48: a computer 53, a remote communications terminal 54, a GPS system 55, a display controller 56 and a display monitor 57. The remote communications terminal 54 includes a transmitter 59 and a receiver 60. The computer 53 and the display controller 56 may be embodied in more than one individual computer. In one embodiment, the computer 53, the display controller 56 and the display monitor 57 are contained in a single piece of portable apparatus, such as a laptop computer.

The communications network 50 is a network, such as the Internet, that facilitates communications between the website 51 and the remote communications terminal 54 located in the individual aircraft 48. In one or more embodiments, the communications network 50 facilitates communications between transmitters 59 and receivers 60 of different individual aircraft 48 independently of the Internet.

The remote communications terminal 54 utilizes Wi-Fi technology and/or GSM technology. Operation of the transmitter 59 and the receiver 60 of the remote communications terminal 54 are controlled by the computer 53.

The GPS system 55 determines the position of the individual aircraft 48 and repeatedly provides an updated position-indication signal 62 indicating the determined position of the individual aircraft 48 and identifying the individual aircraft 48. The position data indicates the latitude, longitude and altitude of the individual aircraft 48. The updated position-indication signal 62 is provided to the computer 53 and the transmitter 59.

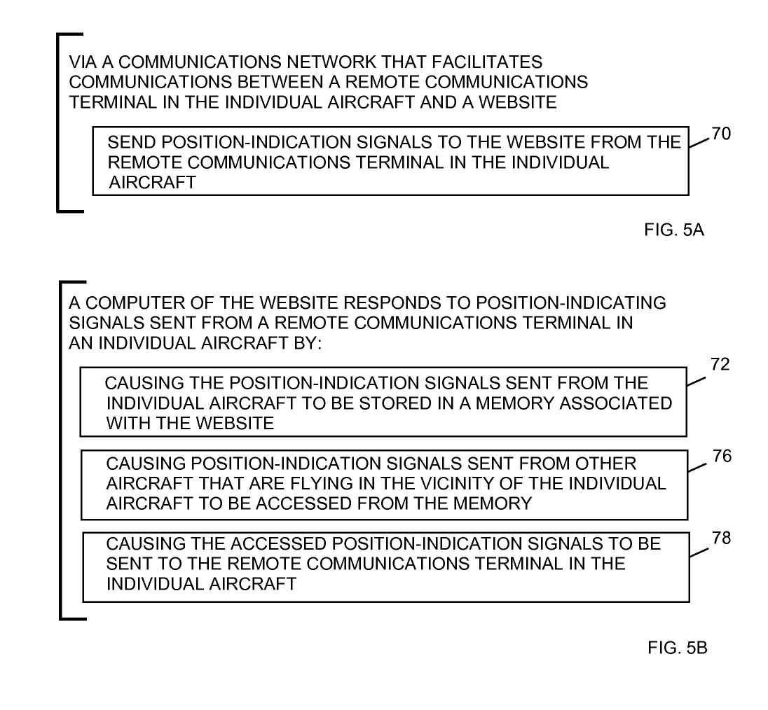

The transmitter 59 of the remote communications terminal 54 repeatedly sends the updated position-indication signals 64 via the communications network 50 from the remote communications terminal 54 in the individual aircraft 48 to the website 51, as shown at 70 in FIG. 5A.

A computer 66 of the website 51 is programmed by computer executable instructions contained in a nontransitory computer readable storage medium. These computer executable program instructions cause the website computer 66 to respond to the position-indication signals 64 sent from the remote communications terminal 54 in an individual aircraft 48 by: (a) causing the updated position-indication signals 64 sent from the remote communications terminal 54 in the individual aircraft 48 to be stored in a memory 68 that is associated with the website 51, as shown in FIG. 4 and at 72 in FIG. 5B; (b) causing updated position-indication signals 74 sent from other aircraft 48 that are flying in the vicinity of the individual aircraft 48 to be accessed from the memory 68, as shown in FIG. 4 and at 76 in FIG. 5B; and (c) causing the accessed updated position-indication signals 74 to be sent to the remote communications terminal 54 in the individual aircraft 48, as shown in FIG. 4 and at 78 in FIG. 5B,

The computer 66 of the website 51 is embodied in one computer or in a plurality of computers, such as, but not limited to, a plurality of computers in a cloud computing network.

The receiver 60 in the remote communications terminal 54 of the individual aircraft 48 continuously receives the accessed updated position-indication signals 74 sent from the website 51.

In one or more embodiments, the GPS system 55 updates the position-indication signals 62 several times per second.

Onboard each of a plurality of individual aircraft 48, the accessed position-indication signals 74 are processed continuously by the computer 53. The computer 53 is programmed by computer executable instructions contained in a nontransitory computer readable storage medium. These computer executable program instructions cause the website computer 66 to process the continuously received position-indication signals 74 and the updated position-indication signal 62 provided by the onboard GPS system 55 to provide display signals 80 to the display controller 56 to thereby enable the display monitor 57 to display a map showing the updated positions of other aircraft 48 flying in the vicinity of the individual aircraft 48 in relation to the position of the individual aircraft 48 in the same manner as the computer 23 processes the position-indication signals 30, 30′ to provide the display signals 32 to the display controller 24 in the embodiment of the system described above with reference to FIG. 1.

The display signals 80 are provided to the display controller 56, which controls the formation of a map by the display monitor 57 in the same manner as the display controller 24 controls the formation of a map by the display monitor 25 in the embodiment of the system described above with reference to FIG. 1 and/or in the above-described alternative embodiments to the system shown in FIG. 1. An exemplary map display is shown in FIG. 2.

The aspects of the method of the present invention described above with reference to FIGS. 3A, 3B and 3C with respect to the embodiment of the system shown in FIG. 1 are also applicable to the embodiment of the system shown in FIG. 4.

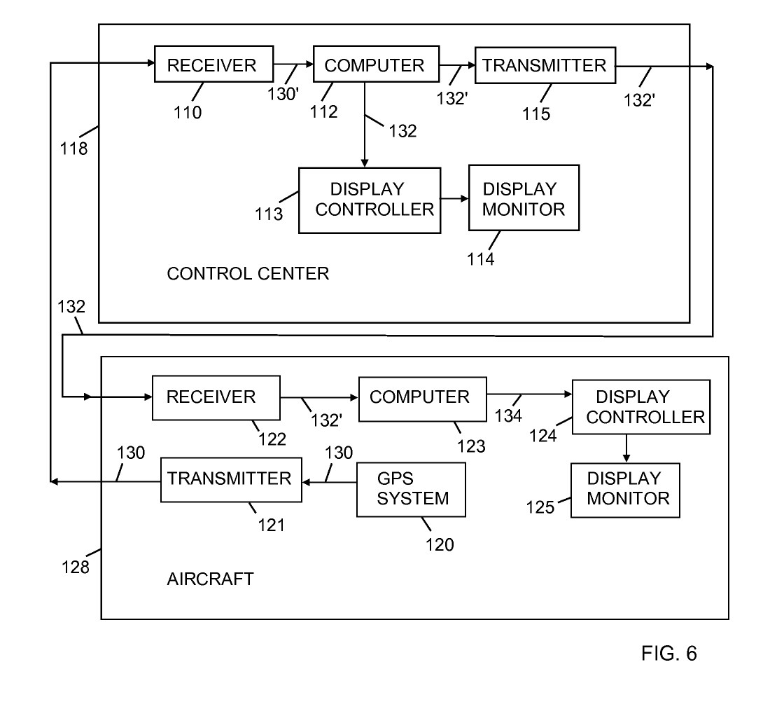

Referring to FIG. 6, an exemplary embodiment of a system according to the further aspect of the present invention includes a receiver 110, a computer 111, a display controller 112, a display monitor 14 and a transmitter 115 at a control center 118; and a GPS system 120, a transmitter 121, a receiver 122, a computer 123, a display controller 124 and a display monitor 125 onboard an individual aircraft 128. Each of the computers 111, 123 may be embodied in more than one individual computer.

The GPS system 120 onboard the aircraft 128 provides GPS signals 130 indicating the position of the individual aircraft 128 and identifying the individual aircraft 128. When the individual aircraft 128 is flying in a sector of airspace controlled by the control center 118, the transmitter 121 onboard the aircraft 128 transmits the GPS signals 130 indicating the position of the individual aircraft 128 and identifying the aircraft 128.

At the control center 118, the receiver 110 receives the GPS signals 130 and provides the received GPS signals 130′ to the computer 111. The computer 111 is programmed to process the GPS signals 130′ to provide position-indicating signals (not shown) that indicate the positions of respective individual aircraft 128; and the computer 111 is also programmed to process these position-indicating signals to provide display signals 132 that enable the display monitor 114 to display a map showing the positions of aircraft flying in a particular sector of airspace controlled by the control center 118.

The computer 111 is also programmed to process the position-indicating signals so that the display signals 132 associate the aircraft positions with the aircraft identities. Preferably, the display signals 132 indicate rectangular longitude and latitude coordinates for the positions of the aircraft.

In one or more embodiments, the computer 111 is also programmed to process a sequence of position-indicating signals for each of different individual aircraft 128 so that the display signals 132 indicate the direction in which each of the different individual aircraft 128 is flying.

The display signals 132 are provided to the display controller 112, which controls the formation of the map displayed by the display monitor 114.

The transmitter 115 at the control center 118 repeatedly transmits at least a portion of the display signals 132′ to aircraft in the particular sector of airspace.

Onboard an individual aircraft 128 that is identified by the display signals 132′ the receiver 122 receives the sent display signals 132′ when the individual aircraft 128 is within the particular sector of airspace.

The onboard computer 123 is programmed for processing the display signals 132′ received from both the individual aircraft 128 and other aircraft flying in the vicinity of the individual aircraft 128 to provide onboard display signals 134 that cause the onboard monitor 125 to display a map showing the positions of other aircraft flying in the vicinity of the individual aircraft 128 in relation to the position of the individual aircraft 128. The display signals 134 are provided to the display controller 124, which controls the formation of the map 36 displayed by the display monitor 25.

An exemplary map display is shown in FIG. 2. The display controller 124 may be operated to adjust the scale of the display map to display the positions of other aircraft that are flying within a selected distance of the individual aircraft 128, such as within five, ten or fifteen miles, for example. On the displayed map, the distance between the circles represents five miles.

The unique identity of the individual aircraft 128 is stored in the display controller 124 that is onboard each individual aircraft 128. The onboard display controller 124 processes the aircraft identities included in the display signals 134 by comparing the stored unique aircraft identity of the individual aircraft 128 with the aircraft identities included in the display signals 134, and upon matching the stored unique aircraft identity with the aircraft identity that is included with the position data in the display signal 134 for the individual aircraft 128, causes the position of the individual aircraft 128 to include a distinguishing feature, such as color or shape, that is not included in the displays of the positions of other aircraft 138, and further causes the display of the position of the individual aircraft 128 to be maintained in approximately the same place on the displayed map, such as the center, while the position of the individual aircraft 128 is changing with respect to the ground.

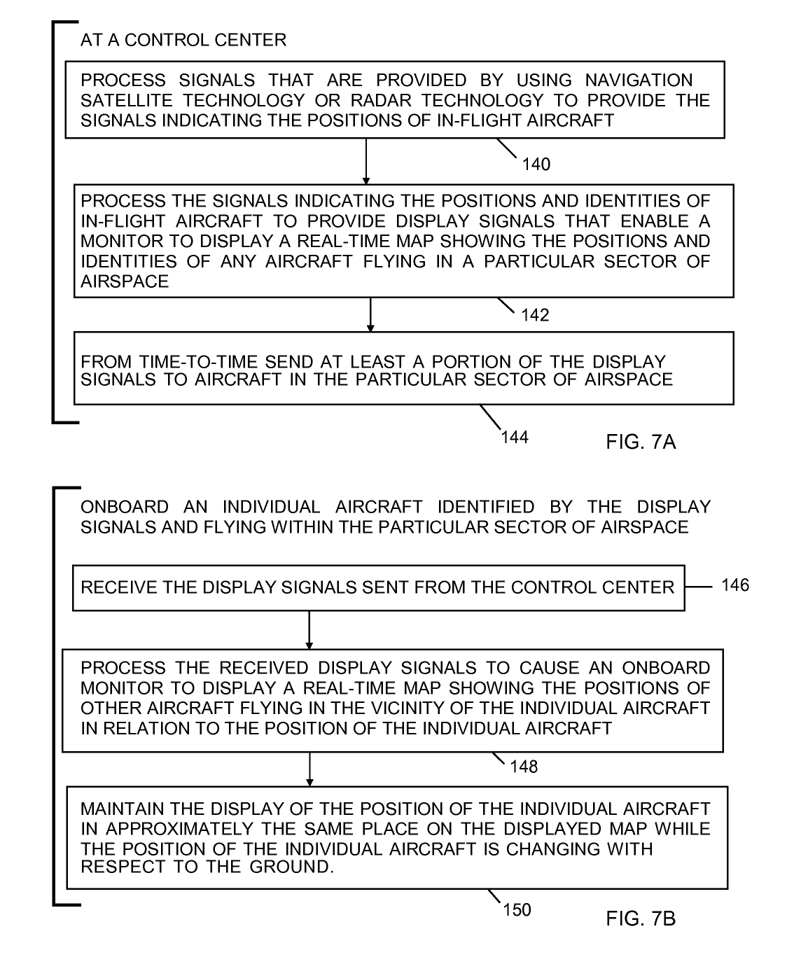

An exemplary embodiment of the method of the further aspect of the present invention is described with reference to FIGS. 7A and 7B.

At the control center, signals that are provided by using navigation satellite technology or radar technology are processed to provide the signals indicating the positions of in-flight aircraft, as shown at 140; the signals indicating the positions and identities of in-flight aircraft are processed to provide display signals that enable a monitor to display a map showing the positions and identities of any aircraft flying in a particular sector of airspace, as shown at 142; and at least a portion of the display signals are repeatedly sent to aircraft in the particular sector of airspace, as shown at 144.

Onboard an individual aircraft 128 flying within the particular sector of airspace, the display signals sent from the control center are received, as shown at 46; the received display signals are processed to cause an onboard monitor to display a map showing the positions of other aircraft flying in the vicinity of the individual aircraft in relation to the position of the individual aircraft, as shown at 148, and the display of the position of the individual aircraft is maintained in approximately the same place on the displayed map while the position of the individual aircraft is changing with respect to the ground, as shown at 150.

In one or more alternative embodiments, the control center computer 111 is programmed for processing signals that are provided by using radar technology instead of, or in combination with, navigation satellite technology to provide the signals that indicate the positions of in-flight aircraft that are processed at the control center 118 to provide the display signals 132.

In one or more alternative embodiments, the onboard computer 23, 53 and/or the control center computer 111 is programmed for processing received aircraft-position-indicating signals to determine the trajectories of the respective aircraft and to provide a warning signal when the determined trajectories indicate a potential collision between at least two of the aircraft.

In one or more alternative embodiments, the signals that indicate the positions of in-flight aircraft do not also include the identities of such in-flight aircraft. In at least some of such embodiments, the identities of such in-flight aircraft are otherwise obtained at the control center 118, by a separate communication between the control center 118 and the individual aircraft 128, and inserted in associate with the respective aircraft position into the display signals 132 that are provided to the display controller 112 and/or into the display signals 132′ that are provided to the transmitter 115.

In one or more alternative embodiments, the communications between the control center 118 and an individual aircraft 128 are effected by using radio technology, Wi-Fi technology, and/or GSM technology.

In one or more embodiments, the nodes of the communication networks 10, 50 are embodied in devices that can communicate via the internet, such as, but not limited to, a personal computer, a MAC, a tablet computer, an i-phone, an i-pad, or an Android-based portable communication device.

In one or more alternative embodiments, the positions of individual aircraft are determined by using navigation satellite technology, in lieu of or in addition to GPS technology, such as the Russian Global Navigation Satellite System (GLONASS), the planned Chinese Compass navigation system, and the European Union's Galileo positioning system.

In other embodiments, the various aspects of the different embodiments described herein are combined with one another to the extent that they are not incompatible with each other.

Regarding the method claims, except for those steps that can only occur in the sequence in which they are recited, and except for those steps for which the occurrence of a given sequence is specifically recited or must be inferred, the steps of the method claims do not have to occur in the sequence in which they are recited.

The benefits specifically stated herein do not necessarily apply to every conceivable embodiment of the present invention. Further, such stated benefits of the present invention are only examples and should not be construed as the only benefits of the present invention. While the above description contains many specificities, these should not be construed as limitations on the scope of the present invention, but rather as examples of the preferred embodiments described herein. Other variations are possible and the scope of the present invention should be determined not by the embodiments described herein but rather by the claims and their legal equivalents.

1. A method of displaying onboard an individual aircraft, a map showing aircraft flying in the vicinity of the individual aircraft, comprising the steps of:
(a) onboard each of a plurality of individual aircraft, determining the position of the individual aircraft and providing a position-indication signal indicating said determined position of the individual aircraft;
(b) via a communications network that enables communications between the 8individual aircraft and other aircraft flying in the vicinity of the individual aircraft, sending position-indication signals from the individual aircraft to other aircraft that are flying in the vicinity of the individual aircraft; and
(c) onboard the individual aircraft, receiving via the communications network position-indication signals sent by other aircraft flying in the vicinity of the individual aircraft, and with a computer, processing the position-indication signals to provide display signals that enable a monitor onboard the individual aircraft to display a map showing the positions of other aircraft flying in the vicinity of the individual aircraft in relation to the position of the individual aircraft;
wherein the communications network is a network for facilitating communications between a remote communications terminal located in the individual aircraft and a website; and
wherein step (b) comprises the steps of:
(d) via the communications network, sending position-indication signals to a said website from a said remote communications terminal in the individual aircraft;
(e) via said website, storing said position-indication signals sent from the individual aircraft in a memory that is associated with said website;
(f) via said website, in response to the position-indication signals sent from the individual aircraft, accessing from said memory, position data sent from other aircraft that are flying in the vicinity of the individual aircraft; and
(g) via the communications network, sending to said remote communications terminal in the individual aircraft, said accessed position-indication signals sent from other aircraft that are flying in the vicinity of the individual aircraft.

2-8. (canceled)

9. A method of displaying onboard an individual aircraft, a map showing aircraft flying in the vicinity of the individual aircraft, comprising the steps of:
(a) with a computer, processing signals indicating the positions of in-flight aircraft to provide display signals that enable a monitor to display a map showing the positions of aircraft flying in a particular sector of airspace;
(b) sending at least a portion of said display signals to aircraft in the particular sector of airspace; and
(c) onboard an individual aircraft flying within the particular sector of airspace, receiving the sent display signals, and with a computer, processing the received display signals to cause an onboard monitor to display a map showing the positions of other aircraft flying in the vicinity of the individual aircraft in relation to the position of the individual aircraft;
wherein step (b) comprises the steps of:
(d) via a communications network that facilitates communications between a remote communications terminal located in the individual aircraft and a website, sending position-indication signals to a said website from a said remote communications terminal in the individual aircraft;
(e) via said website, storing said position-indication signals sent from the individual aircraft in a memory that is associated with said website;
(f) via said website, in response to the position-indication signals sent from the individual aircraft, accessing from said memory, position data sent from other aircraft that are flying in the vicinity of the individual aircraft; and
(g) via the communications network, sending to said remote communications terminal in the individual aircraft, said accessed position-indication signals sent from other aircraft that are flying in the vicinity of the individual aircraft.

10-14. (canceled)

15. A nontransitory computer readable storage medium for use with a computer of a website that is adapted for communicating with remote communication terminals in individual aircraft, wherein the computer readable storage medium contains computer executable program instructions for causing the computer to respond to position-indication signals sent from a said remote communications terminal in a said individual aircraft by:
(a) causing said position-indication signals sent from said remote communications terminal in said individual aircraft to be stored in a memory that is associated with said website;
(b) in response to the position-indication signals sent from the individual aircraft, causing position data sent from other aircraft that are flying in the vicinity of said individual aircraft and stored in said memory to be accessed from said memory; and
(c) causing said accessed position-indication signals to be sent to said remote communications terminal in said individual aircraft.
